(19) United States
(12) Patent Application Publication
(10) Pub. No.: US 2020/0189027 A1
(43) Pub. Date: Jun. 18, 2020

(54) CONSTANT KERF DIEBOARD CUTTING SYSTEM USING LASER AND VISION

(71) Applicant: Seoul Laser Dieboard System Co., Ltd., Lake Forest, CA (US)

(72) Inventor: Kyong Chan LIM, San Diego, CA (US)

(21) Appl. No.: 16/708,228

(22) Filed: Dec. 9, 2019

Related U.S. Application Data
(60) Provisional application No. 62/776,742, filed on Dec. 7, 2018.

(51) Int. Cl. B23K 26/042; B23K 26/38; B23K 26/03; B23K 26/04; B23K 26/08; B23K 26/70

(52) U.S. Cl. CPC B23K 26/042; B23K 26/38; B23K 26/707; B23K 26/048; B23K 26/0876; B23K 26/032

(57) ABSTRACT

Laser cutting a dieboard using a laser cutting system, including: setting a width of material to be removed from the dieboard using the laser cutting system; capturing an image of the width of the material removed by the laser cutting system using at least one image capture unit; measuring the captured width of the material captured on the image using the at least one image capture unit; and comparing the measured width of the material to the set width of the material, and moving a laser head of the laser cutting system up and down to adjust a focal length of the laser cutting system and moving the laser head of the laser cutting system sideways to adjust a speed of the laser head, until the measured width and the set width are substantially similar.

### CROSS-REFERENCE TO RELATED APPLICATIONS

This application claims the benefit of priority under 35 U.S.C. § 119(e) of U.S. Provisional Patent Application No. 62/776,742, filed Dec. 7, 2018, entitled “Constant Kerf Cutting System by using Laser & Vision.” The disclosure of the above-referenced application is incorporated herein by reference.

### BACKGROUND

### Technological Field

The present disclosure relates to dieboard width control using laser and vision.

### Background

Kerf is defined as the width of material that is removed by a cutting process. Thus, the Kerf is used to describe how much wood is removed by a saw, because the teeth on a saw are bent to the side, so that they remove more material than the width of the saw blade itself, preventing the blade from getting stuck in the wood. In the context of the computer-controlled cutting (CNC) with typical cutting processes, kerf is the width of material that the process removes as it cuts through the plate. Therefore, when cutting parts on a CNC plasma or laser machine, accurate cut parts need to be produced, with final dimensions as close as possible to the programmed shape. That is, in accurate cutting, the width of the material cut also needs to be taken into account. However, since each cutting process removes a different amount of material, it is difficult to cut the material into a very precise dimension. Accordingly, to account for the width of the material cut out, CNC devices often automatically offset (“kerf offset”) the tool path so that the finished part is produced to come out close to the programmed dimensions.

### SUMMARY

In general, this disclosure describes apparatus and methods related to dieboard width control using laser and vision.

### BRIEF DESCRIPTION OF THE DRAWINGS

The details of the present disclosure, both as to its structure and operation, may be gleaned in part by study of the accompanying drawings.

FIG. 1 shows one example of a cutting blade attached to a pattern board.

FIGS. 2A through 2D show different focal length of the laser beaming that can affect the Kerf.

FIG. 3 is a block diagram of the laser cutting system coupled with at least one camera and other devices including an air jet in accordance with one implementation of the present disclosure.

FIGS. 4A and 4B show two different perspective views of the laser cutting system in accordance with one implementation of the present disclosure.

FIG. 5 shows a camera being calibrated in accordance with on implementation of the present disclosure.

FIG. 6 is a flow diagram of a laser cutting process coupled to the block diagram of the laser cutting system in accordance with one implementation of the present disclosure.

FIGS. 7A and 7B show the details of the camera system and how it measures the kerf.

FIG. 8 is a clamp and clamp holding unit in accordance with one implementation of the present disclosure.

FIG. 9 is a material pushing unit in accordance with one implementation of the present disclosure.

FIGS. 10-14 show a method for expanding the table in accordance with one implementation of the present disclosure.

FIG. 15 shows hybrid Kerf cutting system in accordance with one implementation of the present disclosure.

FIGS. 16A and 16B show combined process of first cutting using laser (FIG. 16A) and second cutting using cutting tool including spindle motor (FIG. 16B) in accordance with one implementation of the present disclosure.

FIG. 17 shows the current technology using cutting spindle in accordance with one implementation of the present disclosure.

### DETAILED DESCRIPTION

The detailed description set forth below, in connection with the accompanying drawings, is intended as a description of various embodiments and is not intended to represent the only embodiments in which the disclosure may be practiced. The detailed description includes specific details for the purpose of providing a thorough understanding of the embodiments. In some instances, well-known structures and components are shown in simplified form for brevity of description. As used herein, like reference numerals refer to like features throughout the written description.

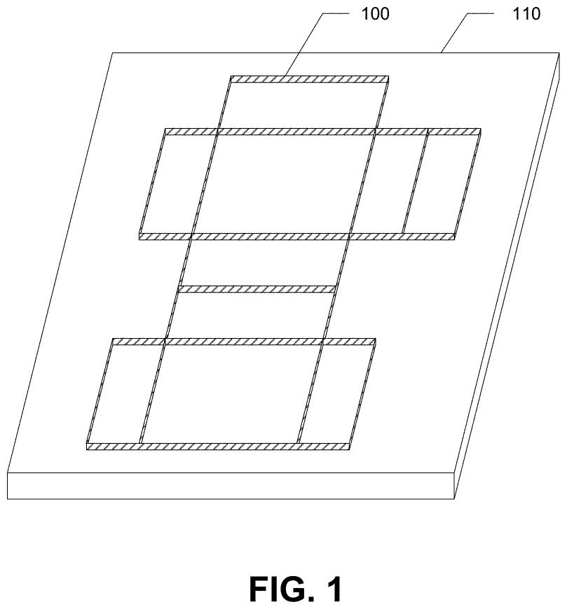

FIG. 1 shows one example of a cutting blade 100 attached to a pattern board 110 (often referred to as a die-board). As shown, the cutting blade 100 of FIG. 1 is folded in a shape suitable for forming the pressed line in the predetermined shape. However, prior to folding or bending the cutting blade 100, the cutting blade needs to be processed so that the cutting blade 100 attaches to the pattern board 110 and is able to cut and/or press the plate matter properly. Further, in attaching the cutting blade 100 to the pattern board 110, the cuts made on the pattern board 110 to insert the cutting blade 100 need to be very precise so that when the cutting blade 100 is inserted and the board 110 presses, the cutting blade 100 does not fall out of the cuts. The pattern board 110 is sometimes referred to as a dieboard.

In one implementation of the present disclosure, the Kerf offset is controlled and adjusted using vision camera coupled with the laser system. Thus, prior to running the program that controls the laser system, a Kerf is entered so that the computer can calculate the actual tool path required to cut the part to the correct dimensions.

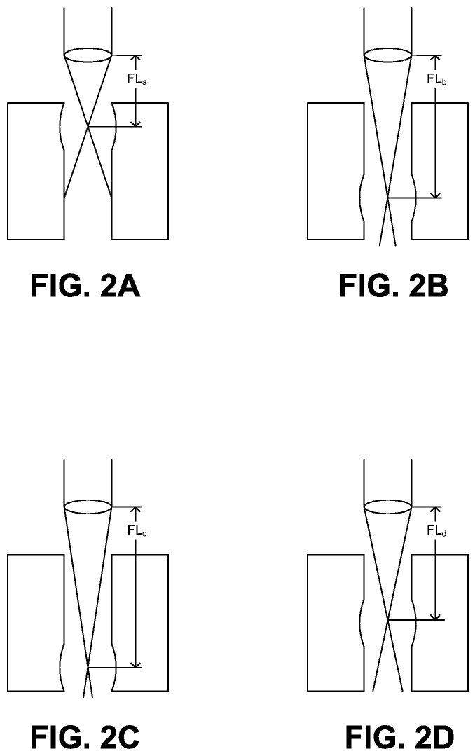

In another implementation, keeping the focal length of the laser beam is important in maintaining constant Kerf. FIGS. 2A through 2D show different focal length of the laser beaming that can affect the Kerf. For example, FIG. 2A has the shortest focal length but shows a large bulge at the top of the cutting material so that the Kerf is not kept constant. FIG. 2B shows a slightly longer focal length than that of FIG. 2A but it still creates a slight bulge in the lower region. FIG. 2C shows even longer focal length than that of FIG. 2B. FIG. 2D has the best focal length that produces most constant Kerf among the examples shown in FIGS. 2A through 2D. Thus, the computer is programmed to use the focal length shown in FIG. 2D. Other parameters similar to the focal length of the laser system may be used to produce the similar result for the constant Kerf.

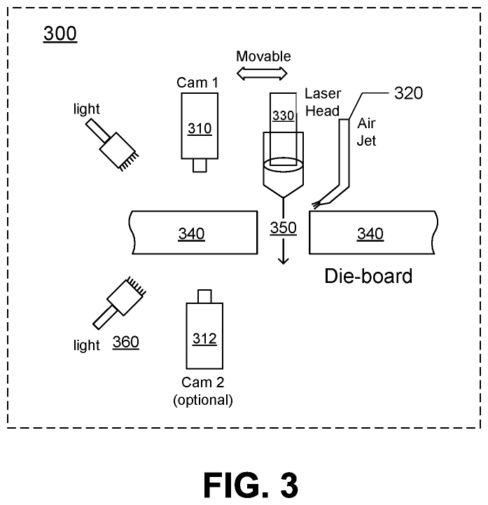

FIG. 3 is a block diagram of the laser cutting system 300 coupled with at least one camera 310, 312 and other devices including an air jet 320 in accordance with one implementation of the present disclosure. In the illustrated implementation of FIG. 3, the laser head 330 is moved above the die-board 340 to make the cut (having a specific Kerf) 350.

In FIG. 3, the body of the cameras 310, 312 and the laser head 330 are installed at a specific distance from each other to complement and enable the laser to work as programmed after the camera work. A spot light 360 is located underneath. The air jet 320 is configured to remove any residue left over from the laser cutting.

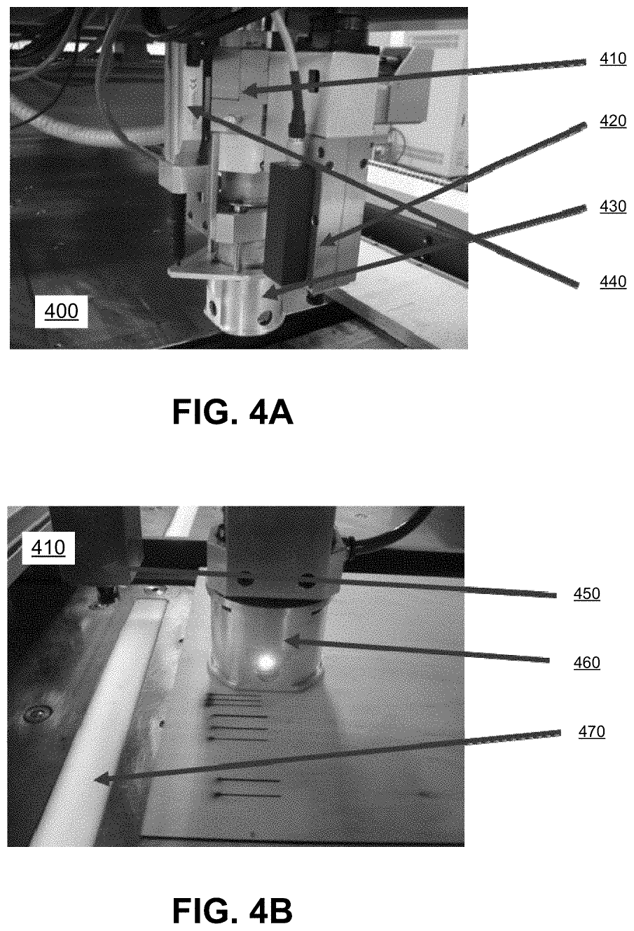

FIGS. 4A and 4B show two different perspective views of the laser cutting system 400 in accordance with one implementation of the present disclosure. In illustrated implementation of FIG. 4A, the laser cutting system 400 includes the laser head 410, the camera (top) 420, the air jet 430, and the movement sensor 440. FIG. 4B shows the camera unit 450, the laser head with the air jet 460, and the light system 470 including the shutter. In one implementation, the laser cutting system 400 uses the cameras to measure the Kerf (width) of the cut being made by the laser head 410. Further, prior to measuring the width using the cameras, the cameras are calibrated.

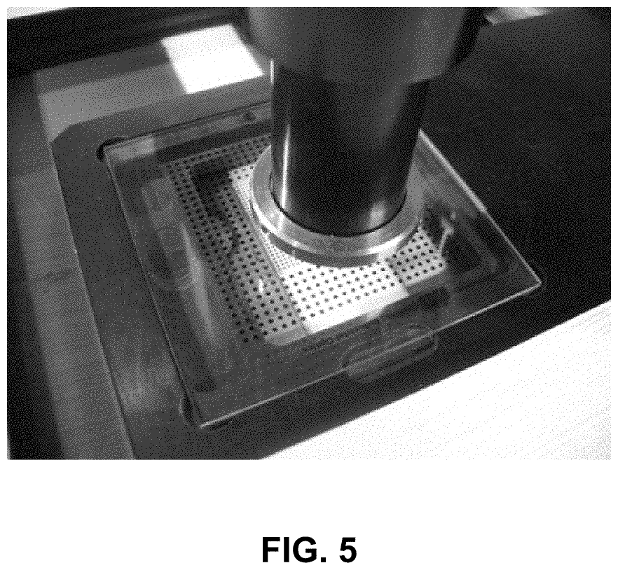

FIG. 5 shows a camera being calibrated in accordance with on implementation of the present disclosure. In the illustrated implementation of FIG. 5, the camera is configured to measure the known distance (XY direction) between the points on a predetermined plate (e.g., a photo of dots) to calibrate it.

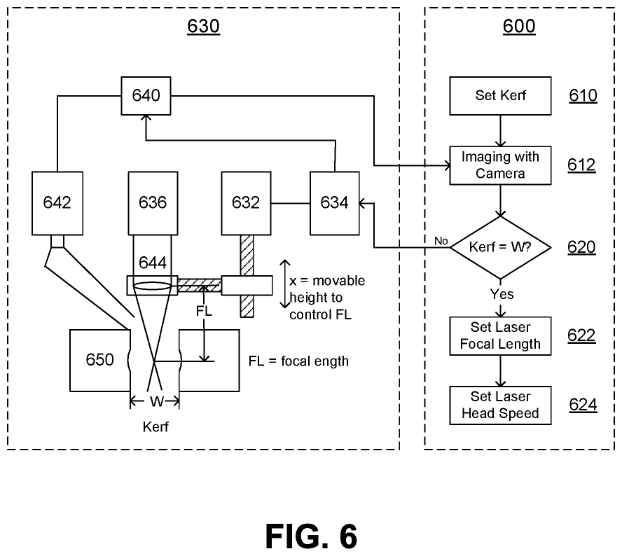

FIG. 6 is a flow diagram of a laser cutting process 600 coupled to the block diagram 610 of the laser cutting system in accordance with one implementation of the present disclosure. In the illustrated implementation of FIG. 6, the process 600 includes setting the Kerf, at step 610, and capturing the image of the Kerf using the cameras 642 and the image capture unit 640, at step 612. The image capture unit 640 may include other imaging units such as image scanners and image sensors. The image capture unit 640 may include other units which process the images captured by the cameras 642 and/or the image capture unit 640. At step 620, the Kerf measured by the cameras 642 (at step 612) is compared to the set Kerf (at step 610). If the measured Kerf is not substantially similar to the set Kerf (i.e., the difference between the measured Kerf and the set Kerf is within 1% of the set Kerf), the process 600 instructs the motor controller 634 (through the servo motor 632) to move the laser head 644 driven by the laser source 636 up or down to adjust the focal length of the laser or sideways to adjust the speed at which the laser head 644 is moved. Steps 612 and 620 are repeated until the set Kerf and the measured Kerf are substantially similar. Thus, if the set Kerf is substantially similar to the measured Kerf (at step 620), the process 600 sets the focal length of the laser, at step 622, the speed (i.e., the speed at which the laser head 644 moves sideways), at step 624. In FIG. 6, element 650 is the dieboard. In another implementation, the setting of the laser focal length (at step 622) and the speed of the laser head (at step 624) is done in real-time so that the parameter setting is done real-time during the imaging (step 612) and comparison (step 620) of the set Kerf and the measure Kerf.

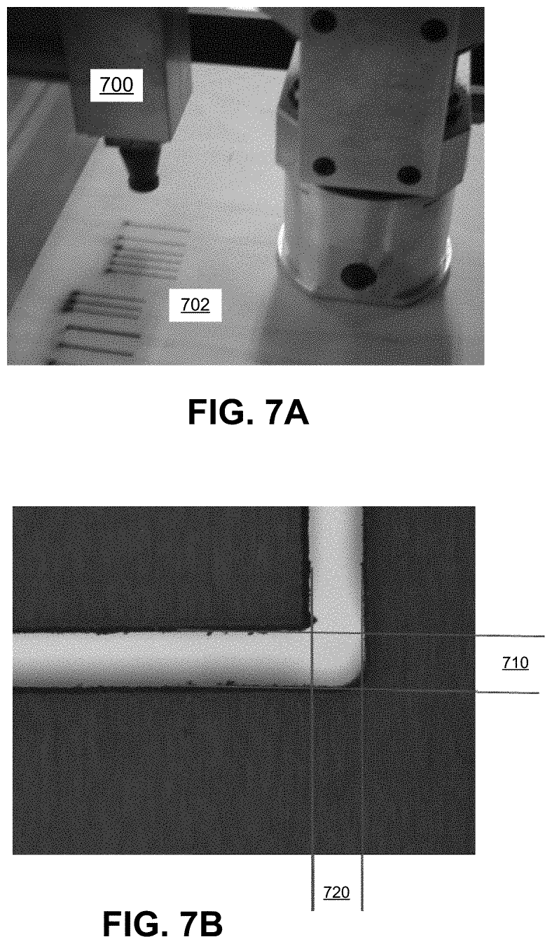

FIGS. 7A and 7B show the details of the camera system 700 and how it measures the kerf. In the illustrated implementation of FIGS. 7A and 7B, the camera system 700 is used to measure the width of the cutting slit 702 on the surface. The height of the laser head is adjusted up or down according to the Kerf of the measured surface, and repeat the laser cutting and camera operation until the optimum Kerf is obtained. As described above, when the shape of the laser beam is not circle, the Kerf to be cut for each direction (i.e., X-Y direction; 710 for X direction and 720 for Y direction) may be different from one another. In this case, the focus control described above should be performed for each X-Y direction. The dusts and burr generated on the cut surface are removed by the image enhanced program on the image using the screen filtering technique so that the accurate cutting width is measured.

Following additional implementations are described.
Auto Expanding XY table working area by using vision system.

1. Abstract

This technology relates to expanding the working area using the vision and clamping system. It is a technology that not only can reduce the size of the equipment but also can be lightweight.

Particularly, it is very important to have the same functions while reducing the weight and size of the equipment. Especially, it is possible to install many other equipment in the same area, and also to install the equipment in a small space. In addition, we can save a lot of money on the equipment, and we can get economic benefit by making the equipment very compact in size while keeping all the same functions and quality.

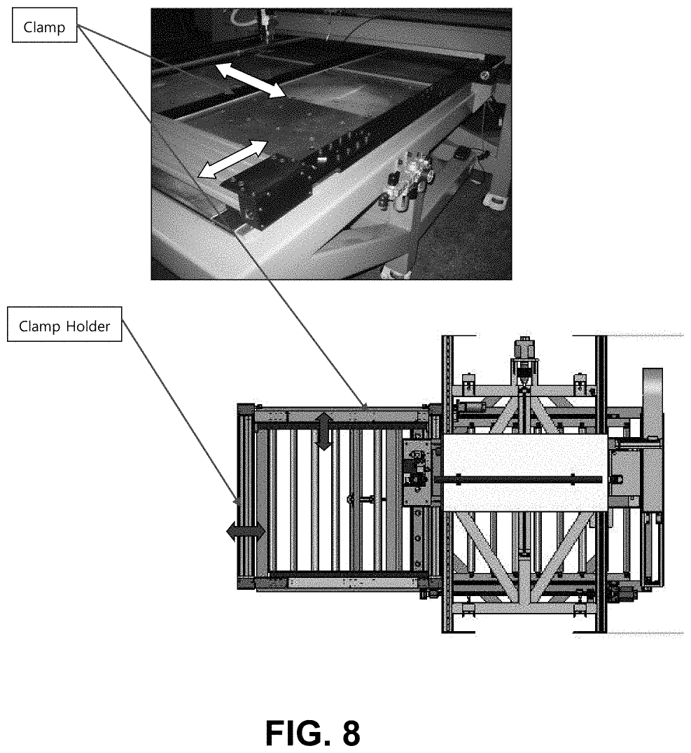

2. Structure

[1] Clamp & Clamp Holding Unit (see FIG. 8)

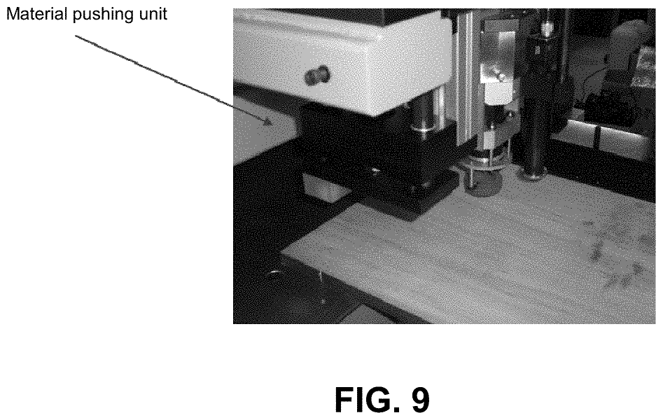

“Clamp” is used to hold the material from the side, which automatically moves from/to left and right depending on the material width. The “Clamp Holder” moves the entire grabbed material front and back the clamp.

[2] Laser Head & Camera and Vision Capturing Unit

[3] Back Light Unit

[4] Material Pushing Unit (FIG. 9)

This unit is a kind of device that holds the material in place when the clamp is released and moved.

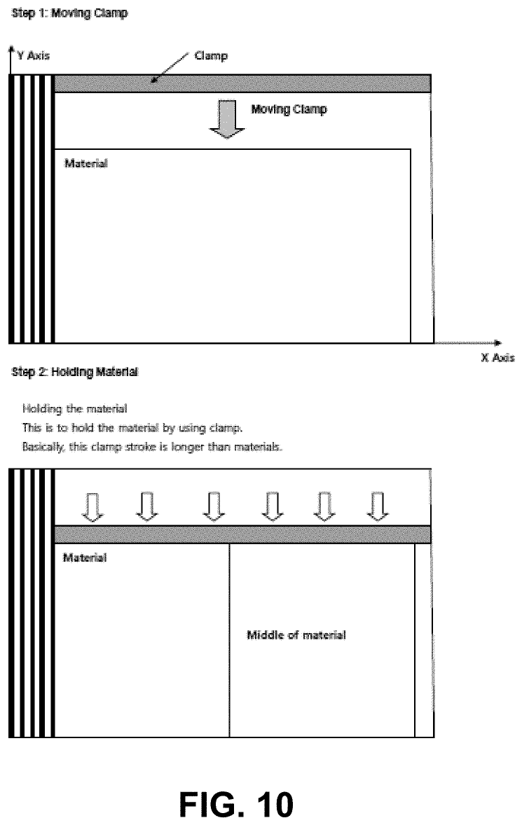

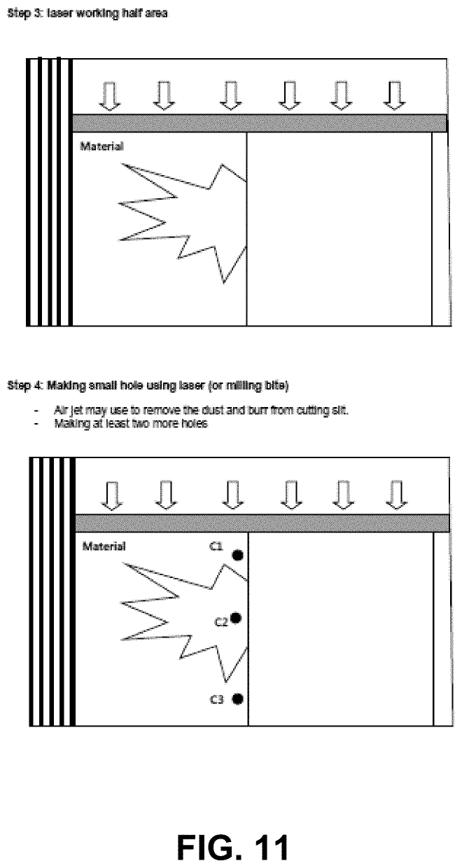

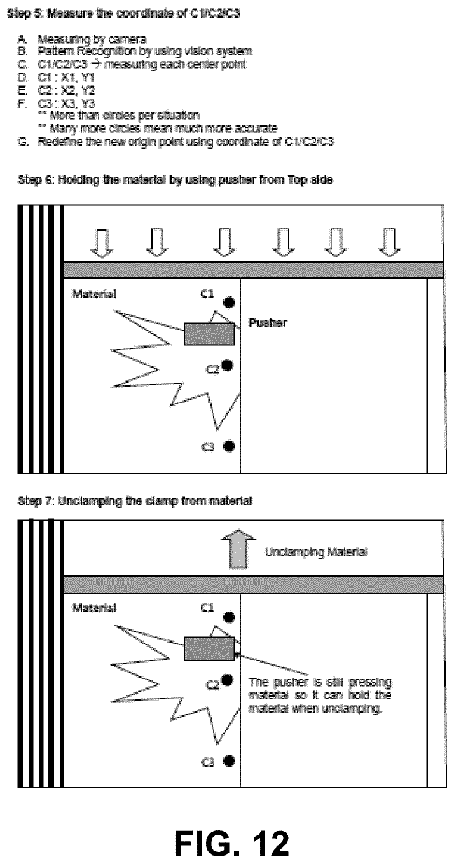

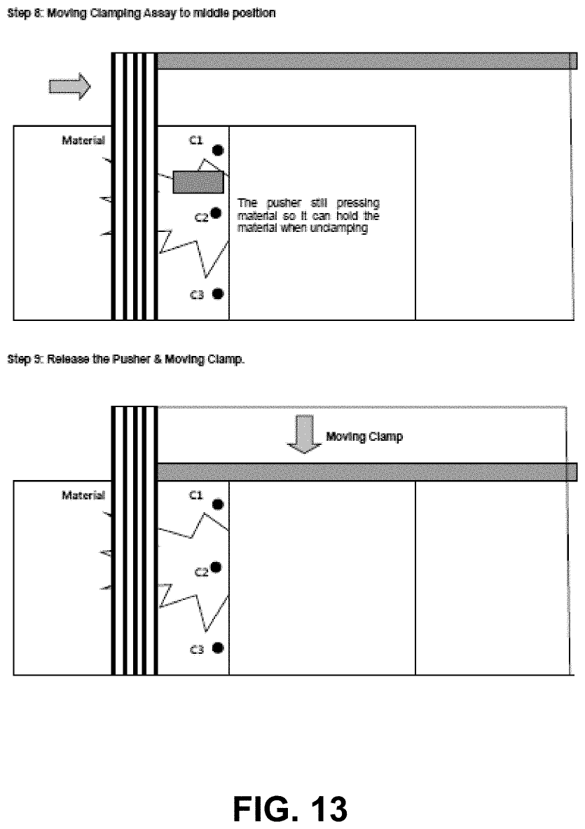

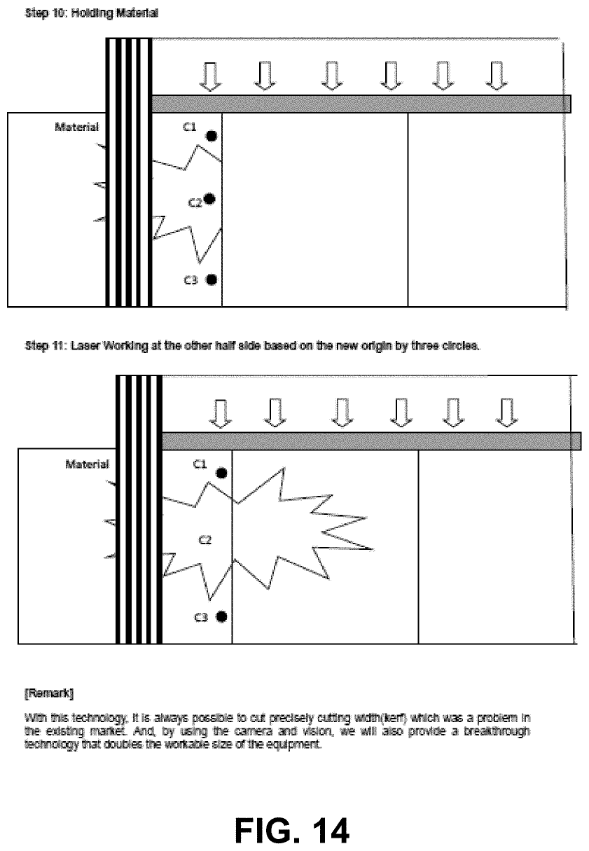

FIGS. 10-14 show a method for expanding the table.

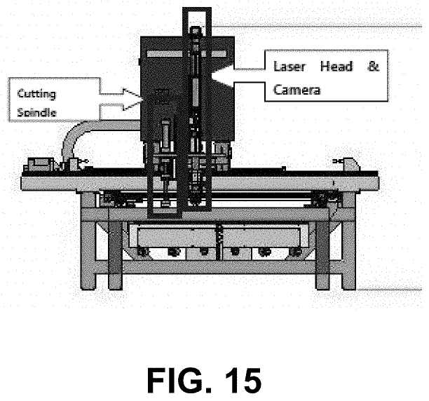

FIG. 15 shows hybrid Kerf Cutting System (Laser+Cutting Spindle).

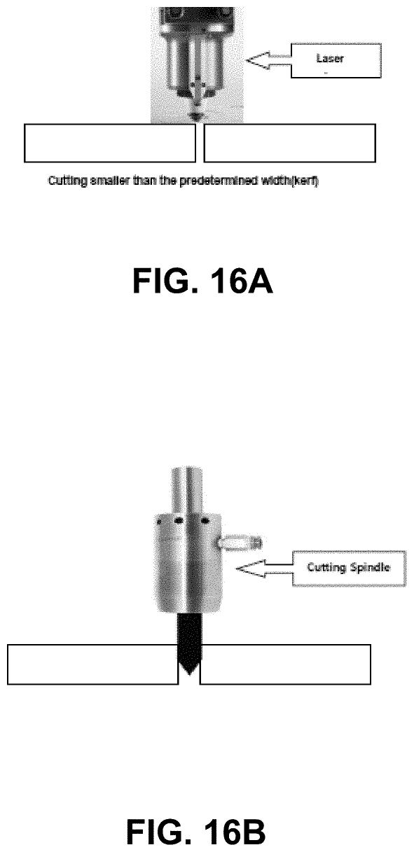

FIGS. 16A and 16B show combined process of first cutting by laser (FIG. 16A) and second cutting by cutting tool using spindle motor.

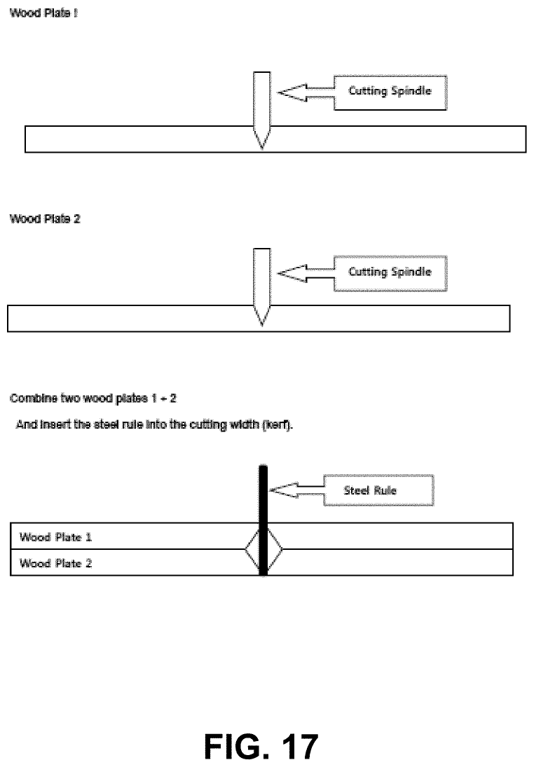

FIG. 17 shows the current technology using cutting spindle.

This technology is to use laser and cutting tools with high speed spindle together for much more accurate and finer cutting (kerf) width control. That is, it is a technology that first cuts the material using a laser beam to a certain extent smaller than a predetermined cutting kerf (width), and then actuates the cutting tool, that is, the width determined by a mechanical method. The kerf using this technology will be the best quality and accurate (“Hybrid” cutting).

The above descriptions of the disclosed embodiments are provided to enable any person skilled in the art to make or use the disclosure. Various modifications to these embodiments will be readily apparent to those skilled in the art, and the generic principles described herein can be applied to other embodiments without departing from the spirit or scope of the disclosure. For example, although the examples shown in the illustrated figures include only one sharp angle made for a channel letter, multiple sharp angles can be made for the channel letter. Thus, it will be understood that the description and drawings presented herein represent embodiments of the disclosure and are therefore representative of the subject matter which is broadly contemplated by the present disclosure. It will be further understood that the scope of the present disclosure fully encompasses other embodiments that may become obvious to those skilled in the art and that the scope of the present disclosure is accordingly limited by nothing other than the appended claims.

Accordingly, the foregoing embodiments are merely presented as examples and are not to be construed as limiting the present disclosure. The present teachings can be readily applied to other types of apparatus and/or devices. The description of the present disclosure is intended to be illustrative, and not to limit the scope of the claims. Many alternatives, modifications, and variations will be apparent to those skilled in the art.

What is claimed is:

1. (canceled)

2. A method of laser cutting a dieboard using a laser cutting system, the method comprising:
setting a width of material to be removed from the dieboard using the laser cutting system;
capturing an image of the width of the material removed by the laser cutting system using at least one image capture unit;
measuring the captured width of the material captured on the image using the at least one image capture unit; and
comparing the measured width of the material to the set width of the material, and
moving a laser head of the laser cutting system up and down to adjust a focal length of the laser cutting system and moving the laser head of the laser cutting system sideways to adjust a speed of the laser head, until the measured width and the set width are substantially similar.

3. The method of claim 2, further comprising
setting the focal length and the speed of the laser cutting system.

4. The method of claim 2, wherein the at least one image capture unit includes at least one camera.

5. The method of claim 4, further comprising
calibrating the at least one camera by measuring a known distance between points on a predetermined plate.

6. The method of claim 2, wherein the at least one image capture unit includes at least one image sensor.

7. The method of claim 2, wherein moving the laser head up and down and moving the laser head sideways are done using a motor controller and a servo motor.

8. The method of claim 2, wherein the measured width and the set width are substantially similar when a difference between the measured width and the set width is within 1% of the set width.

9. A laser cutting system for cutting a slit on a dieboard, the system comprising:
a laser to cut the slit on the dieboard by a width set by the laser cutting system;
at least one image capture unit to capture the cut width of the slit, and to measure the captured width;
a comparator to compare the measured width of the material to the set width of the slit, and
a servo motor controlled by the comparator, the servo motor controlled to move the laser up and down to adjust a focal length of the laser cutting system and to move the laser sideways to adjust a speed of the laser, until the measured width and the set width are substantially similar.

10. The system of claim 9, wherein the laser cutting system sets and stores the focal length and the speed controlled by the comparator using the servo motor.

11. The system of claim 9, wherein the at least one image capture unit includes at least one camera.

12. The system of claim 9, wherein the at least one image capture unit includes at least one image sensor.

13. The system of claim 9, wherein the measured width and the set width are substantially similar when a difference between the measured width and the set width is within 1% of the set width.

14. A non-transitory computer-readable storage medium storing a computer program for laser cutting a dieboard using a laser cutting system, the computer program comprising executable instructions that cause a computer to:
set width of material to be removed from the dieboard using the laser cutting system;
capture an image of the width of the material removed by the laser cutting system using at least one image capture unit;
measure the captured width of the material captured on the image using the at least one image capture unit; and
compare the measured width of the material to the set width of the material, and
move a laser head of the laser cutting system up and down to adjust a focal length of the laser cutting system and move the laser head of the laser cutting system sideways to adjust a speed of the laser head, until the measured width and the set width are substantially similar.

15. The non-transitory computer-readable storage medium of claim 14, the computer program further comprising executable instructions that cause the computer to
set the focal length and the speed of the laser cutting system.

16. The non-transitory computer-readable storage medium of claim 14, the computer program further comprising executable instructions that cause the computer to
calibrate the at least one image capture unit by measuring a known distance between points on a predetermined plate.

17. The non-transitory computer-readable storage medium of claim 14, wherein the executable instructions that cause the computer to move the laser head up and down and move the laser head sideways comprise
executable instructions that cause the computer to move a motor controller and a servo motor.
